(19) United States
(12) Patent Application Publication
(10) Pub. No.: US 2025/0095506 A1
(43) Pub. Date: Mar. 20, 2025

(54) ARTIFICIAL INTELLIGENCE-ASSISTED SUITE HOSTING LEARNING & EXECUTION

(71) Applicant: Sundri Khalsa, East Boston, MA (US)

(72) Inventor: Sundri Khalsa, East Boston, MA (US)

(21) Appl. No.: 18/887,443

(22) Filed: Sep. 17, 2024

Related U.S. Application Data
(60) Provisional application No. 63/584,135, filed on Sep. 20, 2023.

(51) Int. Cl. G09B 7/00; G06F 3/0481; G06F 40/20

(52) U.S. Cl. CPC G09B 7/00; G06F 3/0481; G06F 40/20

(57) ABSTRACT

A system and method based on Artificial Intelligence, systematic process, key principles and techniques of a specified skill/task, and process-guiding templates for helping the users learn, practice, execute, and evaluate performance of the skill/task, or to execute the task for them. The system helps a user prepare for negotiation by providing the user key information and proposed statements and responses to likely challenger points in a structured template. The system enables the user to practice negotiation verbally or via chat box with one or multiple AI or human challengers, while the system listens and provides all parties or only selected parties suggested responses in a private chat box or mobile phone earpiece in real time. The system provides evaluation of negotiation with key metrics and rating of each party's use of the key negotiation principles and techniques on a three-level scale of always used; sometimes used; or never used.

### CROSS-REFERENCE TO RELATED APPLICATIONS

This application claims priority from a U.S. Provisional Patent Appl. No. 63/584,135, filed on Sep. 20, 2023, which is incorporated herein by reference in its entirety.

### FIELD OF INVENTION

The present invention relates to artificial intelligence, software applications, training techniques, and key principles and techniques for specified skills/tasks, such as negotiation, debate, mediation, legal exchange exercises, and game theory.

### BACKGROUND

Traditionally users find information digitally through various search engines, such as Google®, Yahoo®, and the like. These search engines index multiple sources of information, such as web pages, e-books, blogs, databases, and the like. A user typically enters a set of keywords, and the information containing those keywords is presented to the user. The search engines use certain algorithms and logic to show more relevant information to the user. However, most of the time, non-relevant results may be presented to the user which the user has to go through to find the relevant information. This leads to a waste of time and resources.

With advances in artificial intelligence and natural language processing, various software solutions, such as ChatGPT, CoPilot®, Gemini®, and DimeADozen.AI® are being developed that can create a natural dialogue with a user and generate relevant information for the user. Such software solutions can generate concise and relevant information on any suitable topic. Chat GPT enables a user to request information from the AI engine using one free text input field, and then the AI engine answers the request in one free text output field. DimeADozen.AI® enables a user to fill in the requested information in free text fields on a template, and then the AI engine provides a detailed analysis in the form of a report.

AI-based applications that enable a user to engage in conversations with a virtual assistant or a chatbot, where an AI engine takes on a specified role or persona are also getting popular. For example, one such application is the use of AI-enabled Chatbots in Customer Service. Many companies are using AI-powered chatbots on their websites or messaging platforms to handle customer queries, provide support, or instruct users through a process. Like chatbots, Virtual assistants allow users to interact with an AI engine in a conversational manner, wherein the users can ask questions, request actions, set reminders, and more. Examples of virtual assistants include Amazon Alexa®, Google Assistant®, and Apple Siri®.

AI-based interactive Storytelling applications have opened a new dimension to story reading. These applications use AI to create interactive stories where users can engage with characters or the story's environment through dialogue and choices, influencing the story's outcome. AI-powered educational applications are changing the way users learn. These applications can engage with users in conversations to facilitate learning. These apps can teach languages, provide tutoring, or help users practice various skills in a conversational format.

Role-playing games (RPGs) are another area wherein AI and natural language processing are being used extensively. In certain RPGs or adventure games, AI-controlled characters or companions can engage in conversation with the player, providing information, and advice, or advancing the storyline based on the user's choices.

AI-driven Therapeutic Conversational Agents are used in mental health applications to engage with users in a therapeutic role, providing support, guidance, or even simulating a counseling session. Language Learning Applications use AI to engage users in conversations to help them practice and improve their language skills. AI-driven avatars in virtual reality (VR) or augmented reality (AR) environments can engage in conversations, guide users, or act as companions in simulated scenarios. Similarly, Artificial Intelligence, natural language processing, and image recognition techniques have been used in various sectors and processes.

AI-based negotiation applications in which an AI engine can negotiate with a user like a human are also being developed. For example, commerce platforms are deploying AI-powered negotiation applications with a chatbot to connect with suppliers.

Besides several developments in artificial intelligence and natural language processing, the scope for improvement exists in negotiation and evaluation-based applications. Many people facing a task that involves specialized skills, such as negotiation, lack knowledge on how to prepare for the task and lack confidence in that kind of situation. Currently, many individuals rely on their limited knowledge and experience, which often leads to suboptimal outcomes. Existing solutions, such as books or courses, provide theoretical knowledge and may include practical application and personalized feedback, but human instructor time constraints limit the amount of personalized feedback that can be provided. Moreover, human practice partner scheduling conflicts and constraints limit the number of practice sessions that can be performed. Additionally, preparing for skill-intensive tasks, such as negotiation, is time-consuming for negotiation professionals and laymen alike

Developing AI and natural language processing-based new applications for interactions with humans is always desired.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

In one aspect, disclosed are a system and method that can use Artificial Intelligence (AI), a systematic process, key principles and techniques of a specified skill/task, and process-guiding templates to help users learn, practice, execute, and evaluate the performance of the skill/task, or to execute the task for them. The disclosed system can combine guidance on negotiation techniques, tailored negotiation scenario information, practice sessions, personalized coaching, and assistance in actual negotiations in real-time via a private chat box or mobile phone earpiece. The disclosed system offers a one-stop solution that not only trains users and allows them to practice and receive feedback in a realistic setting, but also assists them in preparing faster for a negotiation and assists them during an actual negotiation in real time.

In one aspect, disclosed is a system based on artificial Intelligence (AI), a systematic process, key principles and techniques of a skill/task, and process-guiding templates for helping users learn, practice, execute, and evaluate the performance of the skill/task, or to execute the task for them, the system comprising a processor and a memory, the system configured to implement a method comprising receiving a selection of a skill/task from a list of skills/tasks presented on a home screen of an interface implemented on a user device by the system; receiving answers to one or more question sets from a user for a negotiation exercise through an interface implemented on the user device, wherein the answers are received through free text fields, wherein some questions of the one or more question sets remain unanswered; generating, using artificial intelligence, answers to the unanswered questions; improving by the system, using artificial intelligence, the answers received by the system from the user; receiving any modifications to the answers generated by the system and improvements made, from the user; displaying, by the system, concise bulleted description of key negotiation principles and techniques from accredited education institutions and publications on the user device; advising, by the system, key principles and techniques for the selected skill/task during the execution of the skill/task; and implementing a first chat box on the user device through the interface for allowing the user to practice/converse the skill/task with other users or the system.

In one aspect, the first chat box is configured to allow the user to practice/converse using text messages. The first chat box is further configured to allow the user to practice/converse verbally, wherein the system is configured to read for the user. The system is configured to read/listen to the first chat box. The system is configured to analyze the conversations in the first chat box in near real-time and present suggestions on the practice/conversation through a second chat box, the second chat box is private to the user. The system is configured to receive queries from the user related to the practice/conversation through the second chat box. The system is further configured to evaluate the performance of the user in applying the key principles and techniques for the selected skill/task in the practice/conversation.

In one aspect, the skill is selected from a group consisting of negotiation; mediation; debate; legal exchange exercise; policy initiative, improvement, and evaluation; choice making; game theory; forecasting (predictive assessment); situational intelligence assessment; risk assessment & management; problem solving; strategy making; plan implementation & supervision; Leadership, influencing, and supervising; and persuasive communication. The evaluation is on a three-level scale, the three-level scale includes always used, sometimes used, or never used. The answers can be from known knowledge or guesstimate, wherein each answer is marked as known or guesstimate respectively.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a block diagram showing the environment of the system, according to an exemplary embodiment of the present invention.

FIG. 2 is a block diagram showing the architecture of the system, according to an exemplary embodiment of the present invention.

FIG. 3 is a flow chart illustrating the method, according to an exemplary embodiment of the present invention.

FIG. 4A shows a zone of possible agreement: bargaining zone.

FIG. 4B shows the negative zone of possible agreement: the bargaining zone.

FIGS. 5-27 show different screens of the interface, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the allowed claims of any resulting patent will best define the scope of the invention.

Disclosed are a system and method based on Artificial Intelligence (AI), a systematic process, key principles and techniques of a specified skill/task, and process-guiding templates for helping users learn, practice, execute, and evaluate the performance of the skill/task, or to execute the task for them. The skills include negotiation; mediation; debate; legal exchange exercise; policy initiative, improvement, and evaluation; choice making, game theory, forecasting (predictive assessment), situational intelligence assessment; risk assessment & management; problem-solving; strategy (a plan designed to overcome obstacles); plan implementation & supervision; Leadership, influencing, and supervising; and persuasive communication.

In certain implementations, the system can help a user prepare for a negotiation by providing the user key information and proposed statements and responses to challenger points in a structured template. The system can enable a user to practice negotiation verbally or via chat box with one or multiple AI or human challengers, while the system listens and provides all parties or only selected parties suggested responses in a private chat box or cell phone earpiece in real time. The system can give the user an evaluation of the negotiation with key metrics and rating of each party on the use of the key negotiation principles and techniques on a three-level scale of always used; sometimes used; or never used. If requested, the system can also provide the user with a recording and/or a transcript of the negotiation. If requested, the system can provide the user with near real time guidance and suggested responses in a private chat box or mobile phone earpiece during an actual negotiation. If requested, the system can also perform a task for the user, so for example, the system can function as a negotiator or as a mediator for users.

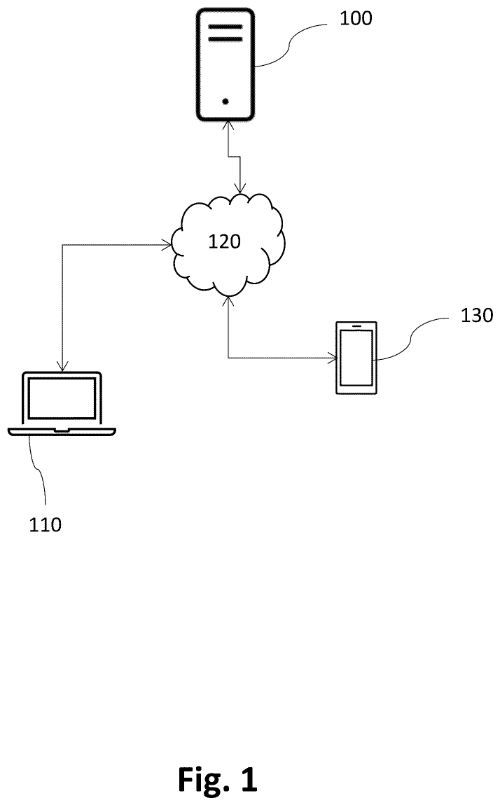

Referring to FIG. 1 which is a block diagram showing an environment of system 100. System 100 can connect to a first user device 110 through a network 120. The system can also connect to a second user device 130 though the network 120. The first user device and the second user device may be a part of a negotiation or debate. The term “user” as used herein, and throughout this disclosure, refers to an individual engaging a user device to interact with the system.

The user device can be any computing device that includes a processor for processing instructions stored in memory. The user device can also include an input module for receiving input from the user. Such input can be in the form of a touch display, mouse, stylus, keyboard, touchpad, and the like. The user device may also include a display for presenting information to the user, for example, an LCD screen. The user device may also include a network circuitry for connecting to the network 120. Examples of the user device include a smartphone, a desktop computer, a laptop, a workstation, and the like.

The network can be a communication network known in the art which can be a wired network, a wireless network, or may include a combination of wired and wireless networks. Examples of communication networks may be a local area network (LAN), a wide area network (WAN), a wireless WAN, a wireless LAN (WLAN), a metropolitan area network (MAN), a wireless MAN network, a cellular data network, a cellular voice network, the Internet, etc. While, for the purpose of illustration herein, FIG. 1 shows a single network connecting multiple user devices, it should be obvious to those reading this disclosure that different user devices can connect with the system through various networks, and the same user device can connect with the system through more than two networks. For example, a user device can connect to the system through a LAN and the Internet.

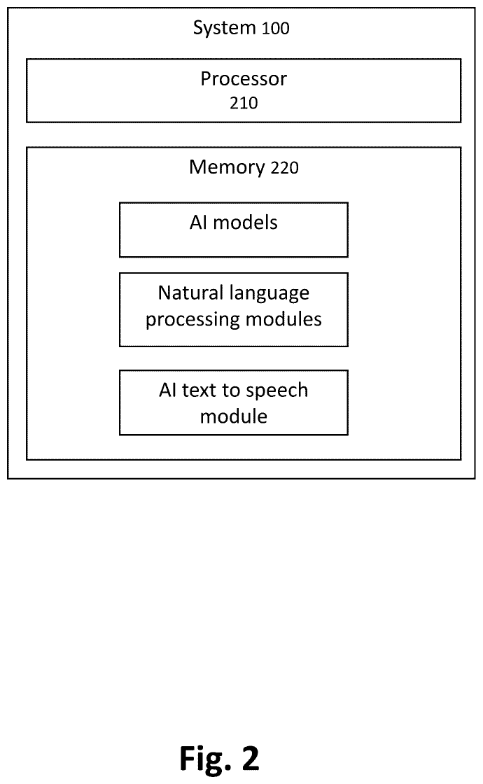

Referring to FIG. 2, system 100 may include a processor 210 and a memory 220 operably coupled to the processor. The processor can be any logic circuitry that responds to, and processes instructions fetched from the memory. The memory may include one or more memory chips capable of storing data and allowing any storage location to be directly accessed by the processor. The memory can include modules according to the present invention for execution by the processor to perform one or more steps of the disclosed methodology.

The term module as used herein and throughout this disclosure refers to software, a program code, a set of rules or instructions, and the like in one or more computer-readable languages including graphics, which upon execution by the processor performs one or more steps of the disclosed methodology. Also, operations may be described as a sequential process, some of the operations may be performed in parallel, concurrently, and/or in a distributed environment, and with program code stored locally or remotely for access by single or multi-processor machines. In addition, in some implementations, the order of operations may be rearranged without departing from the spirit of the disclosed subject matter.

The system can be implemented in the form of servers, which include cloud servers. The servers can be placed in one location or geographically dispersed. Also, one or more steps of the disclosed methodology can be performed on one or more user devices without departing from the spirit of the disclosed subject matter.

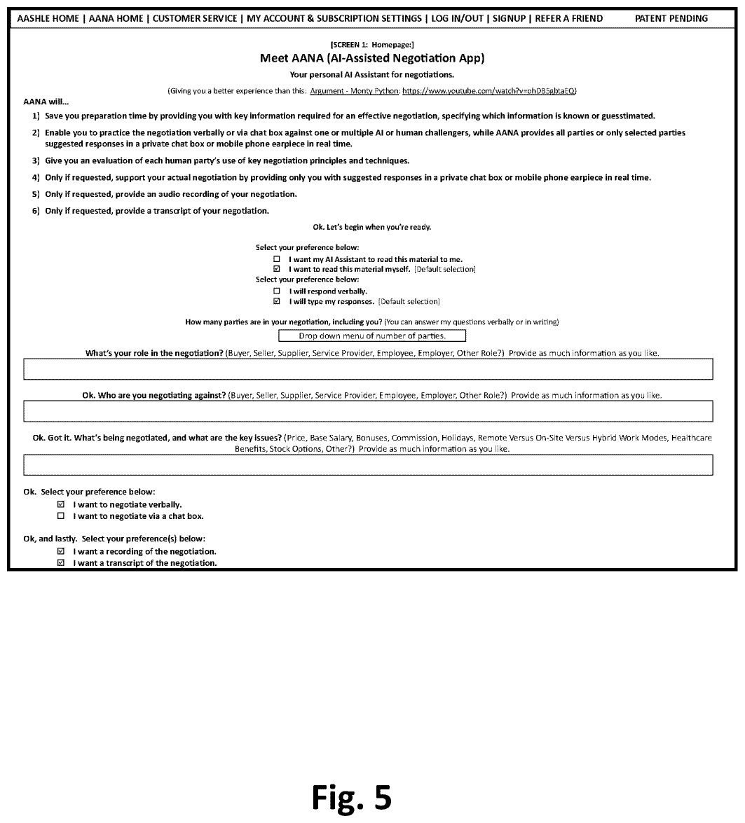

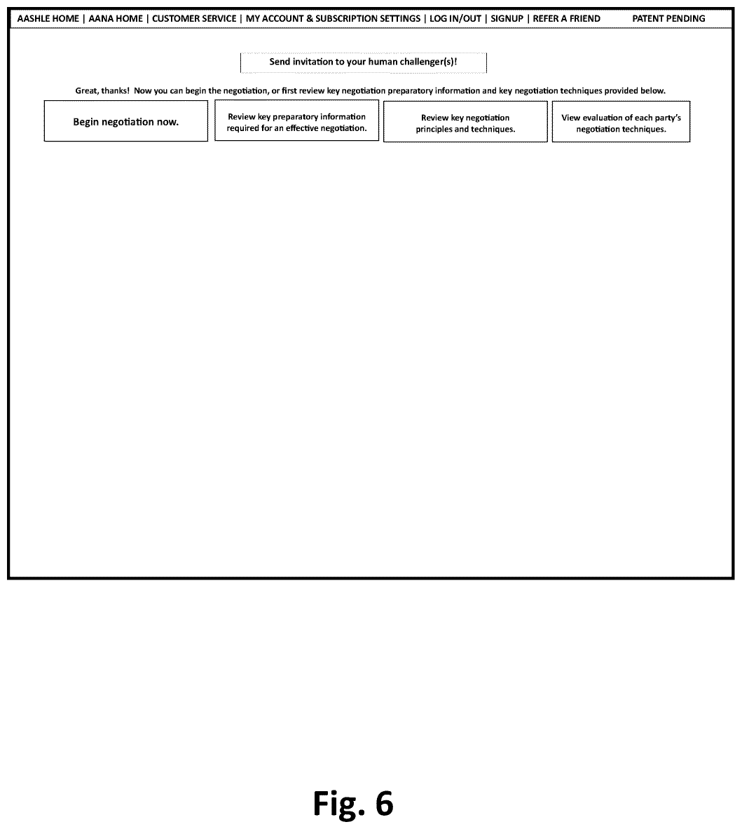

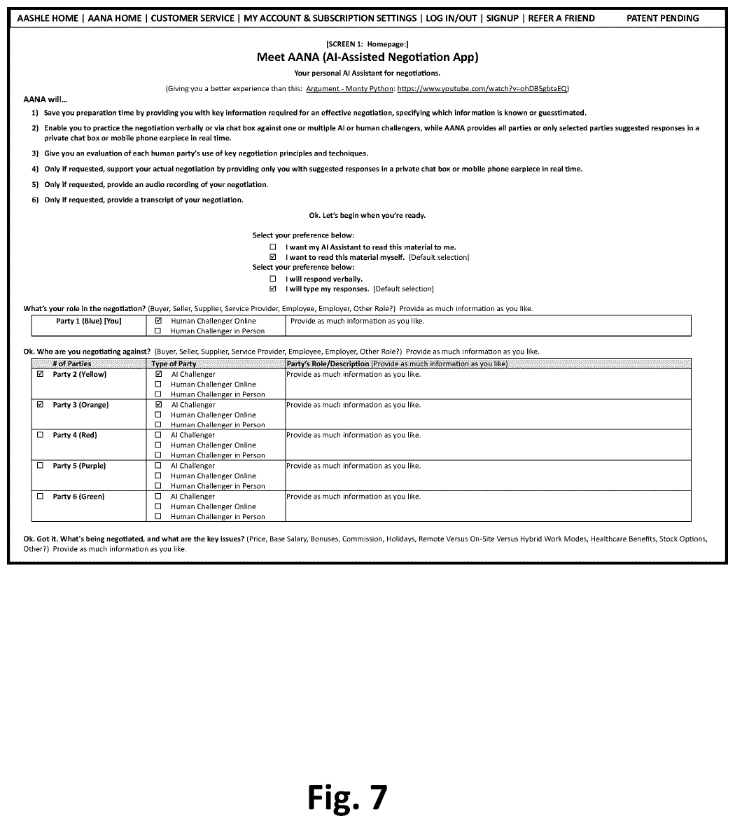

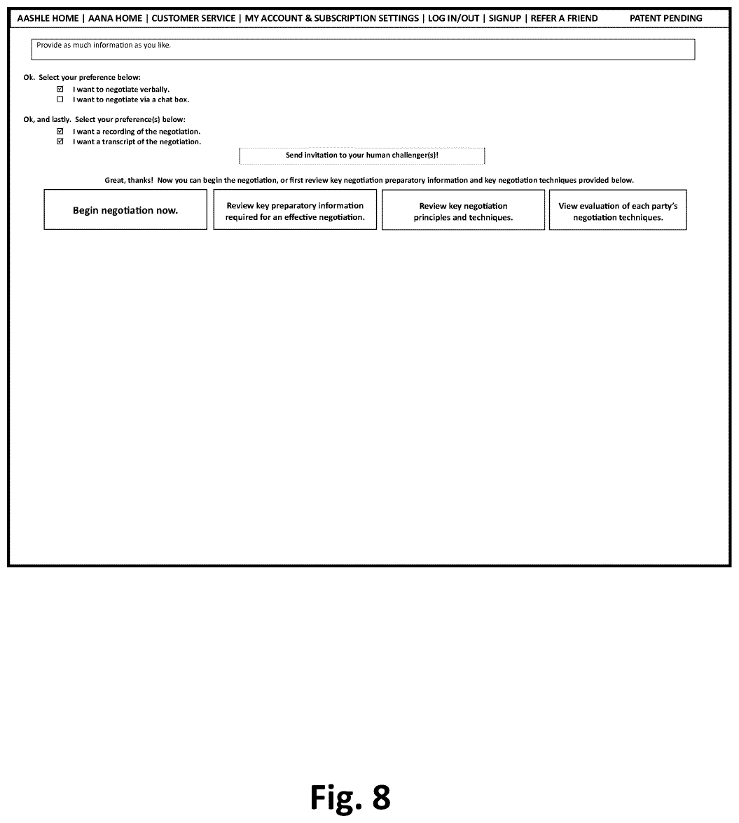

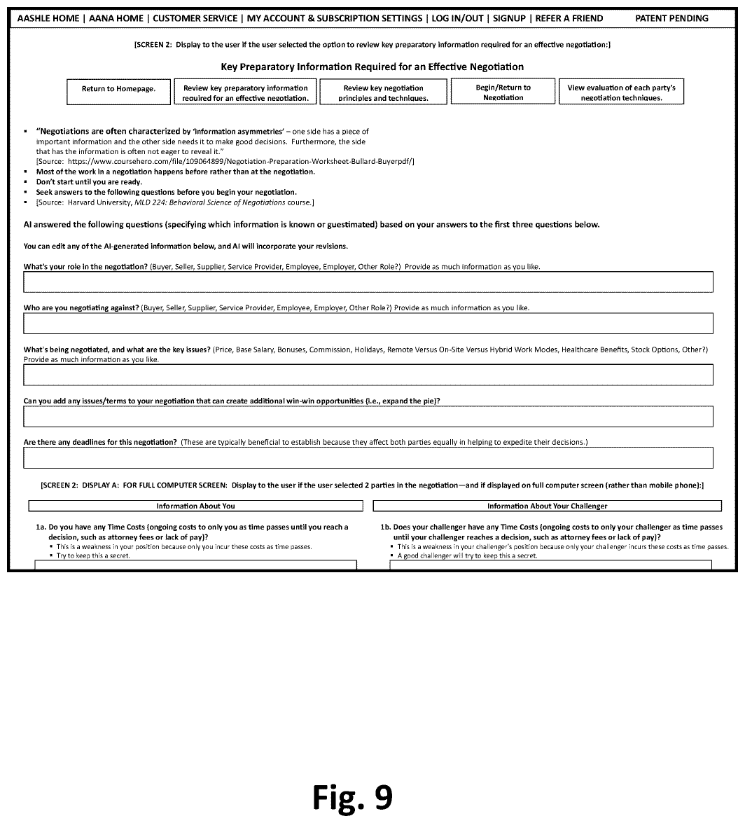

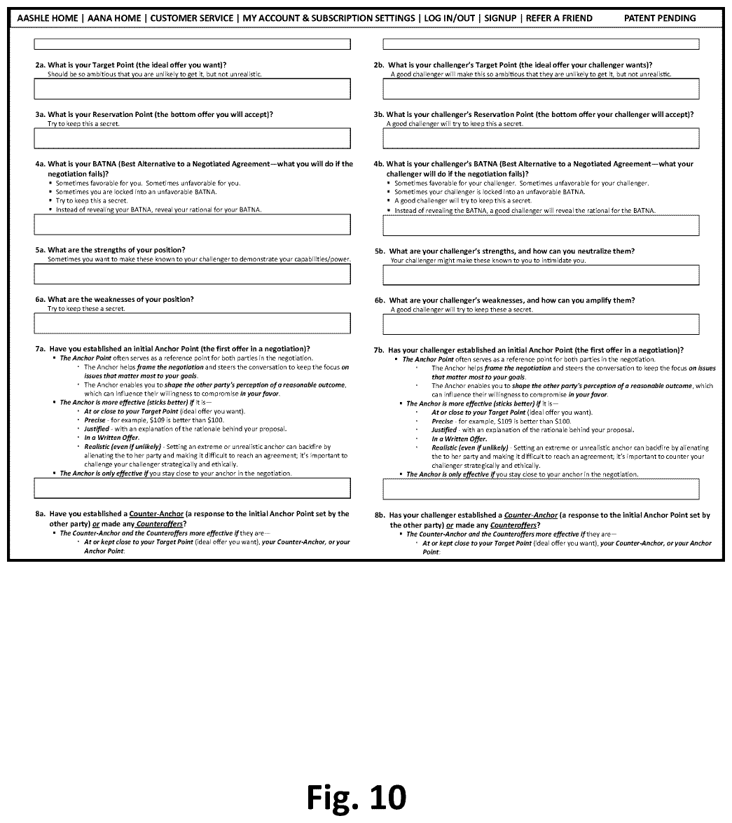

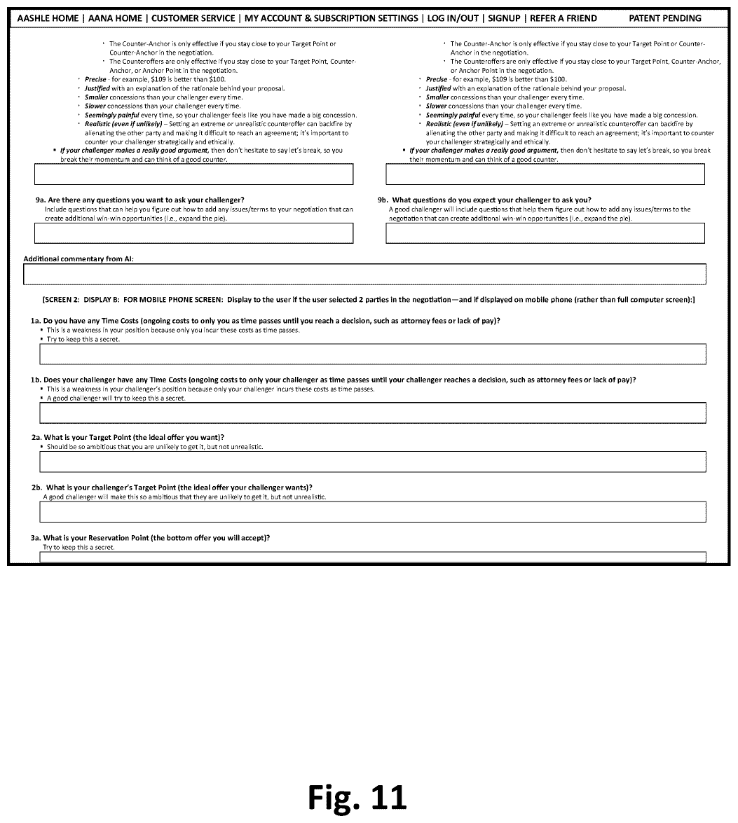

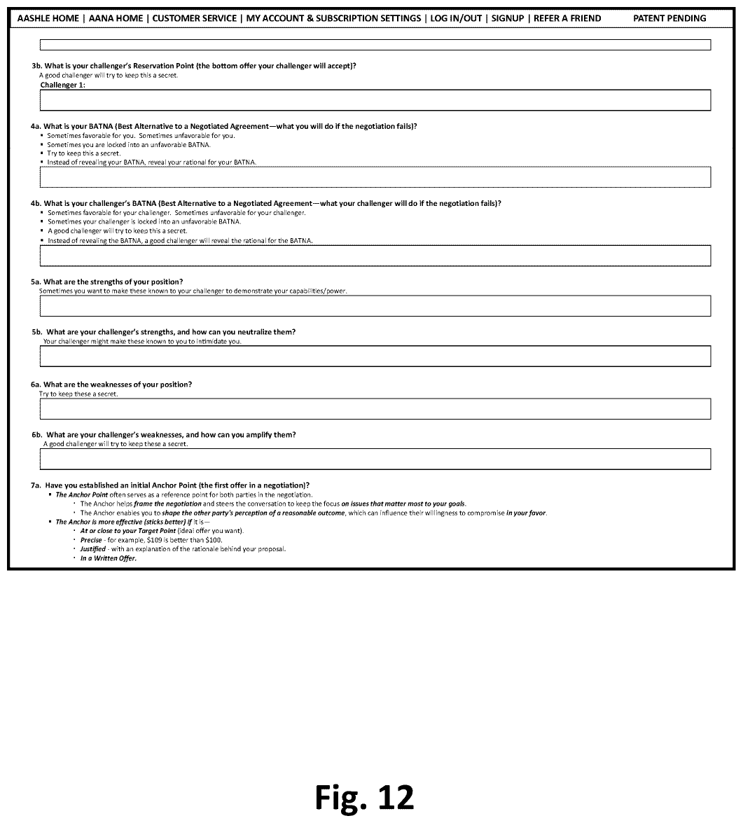

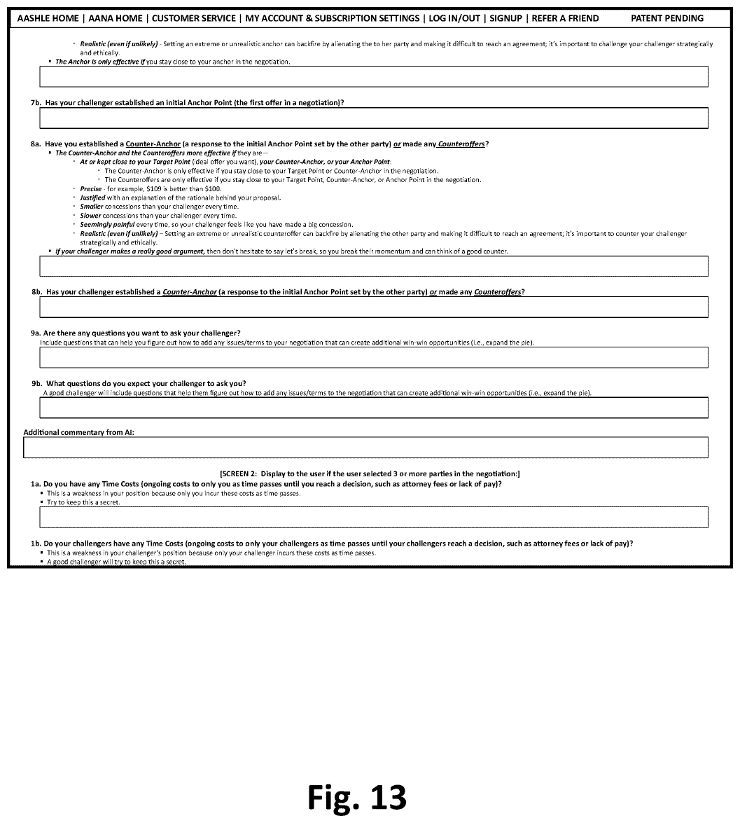

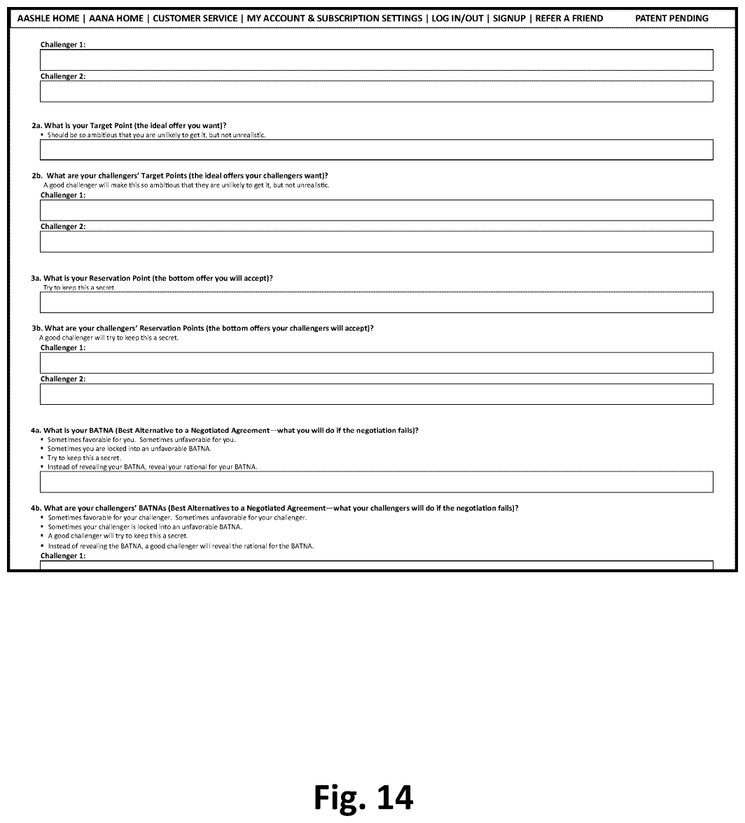

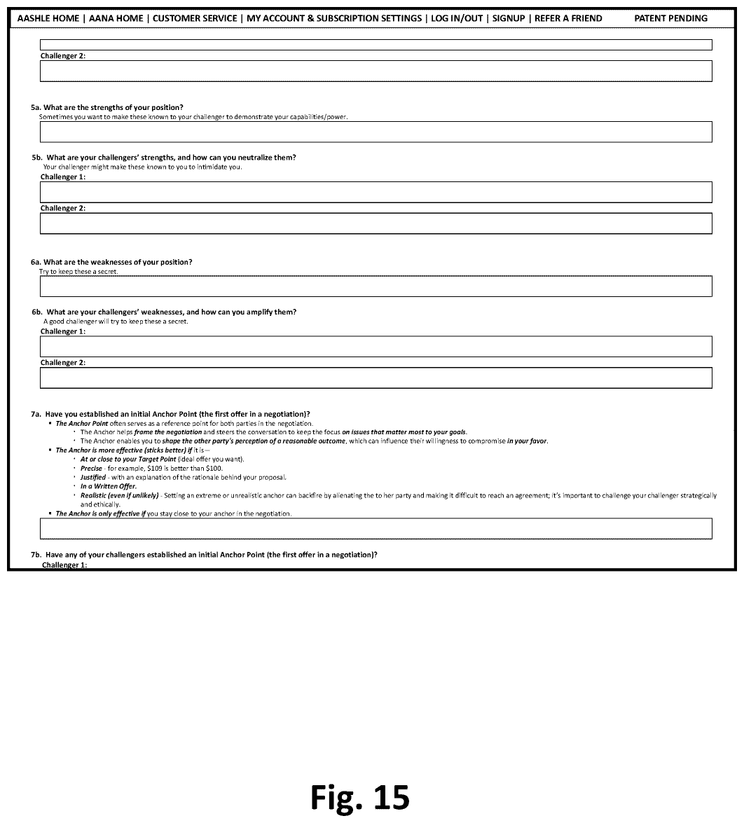

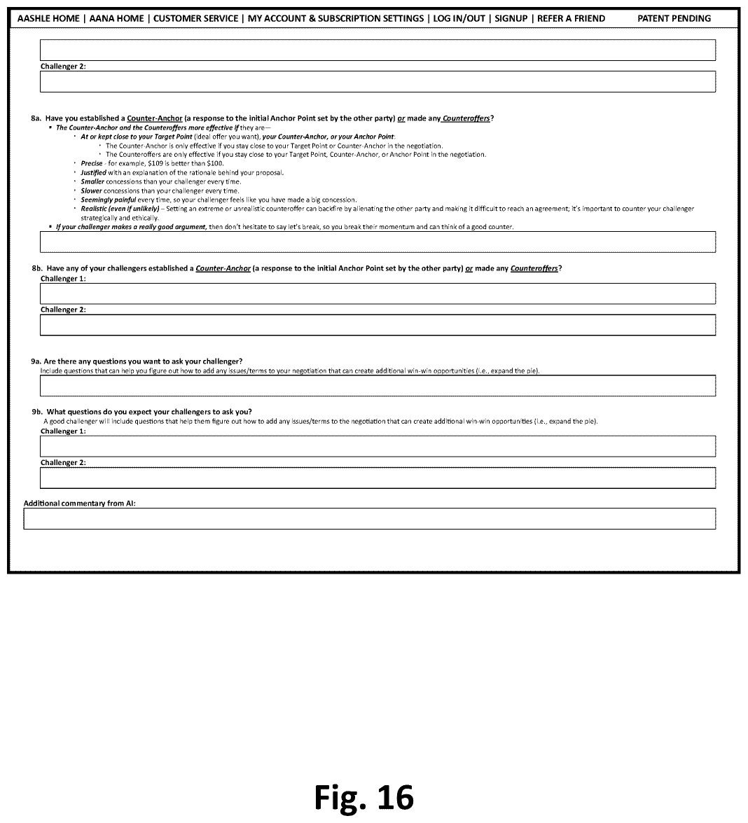

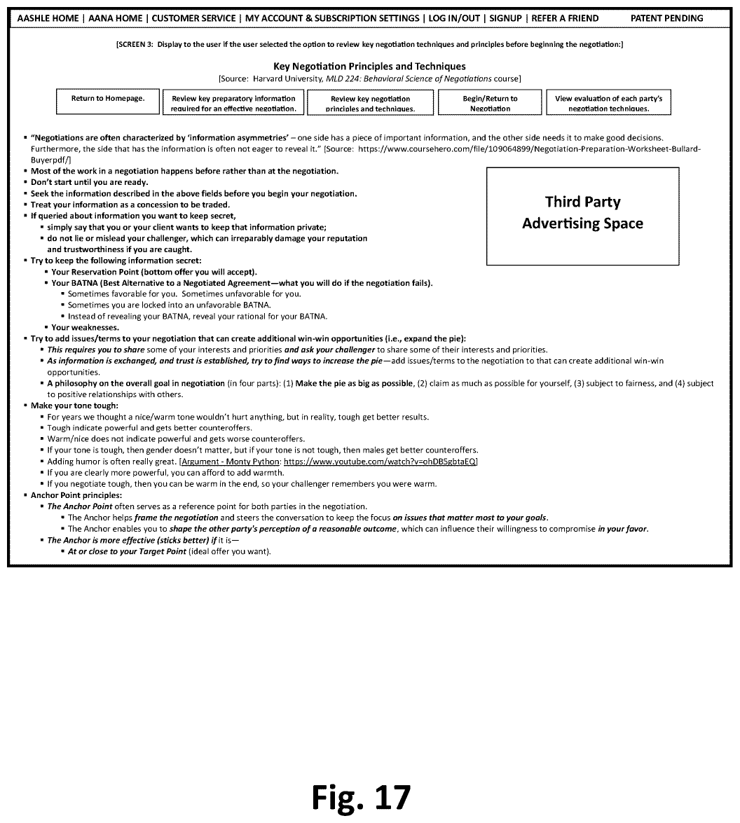

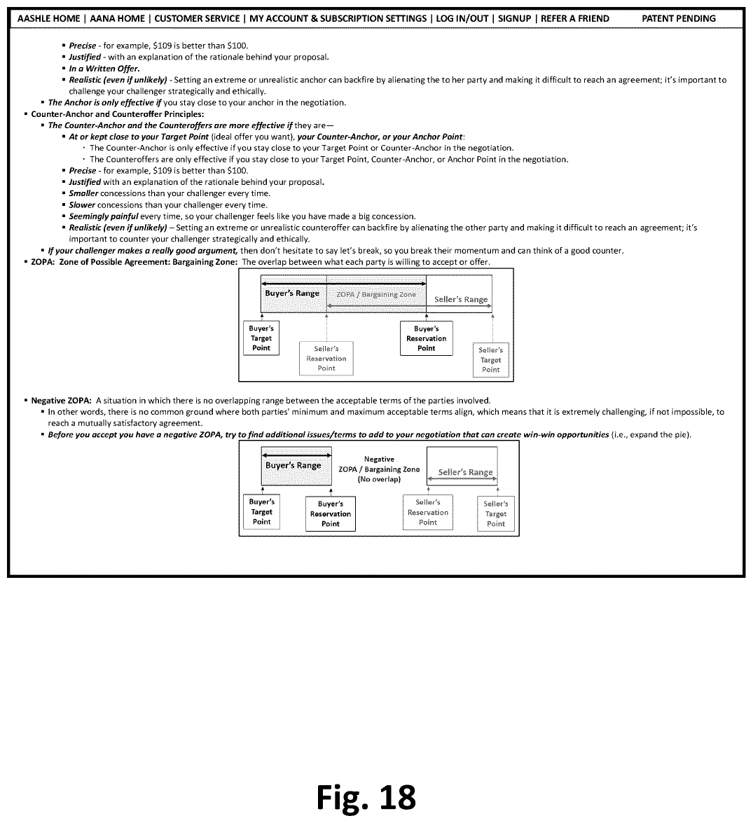

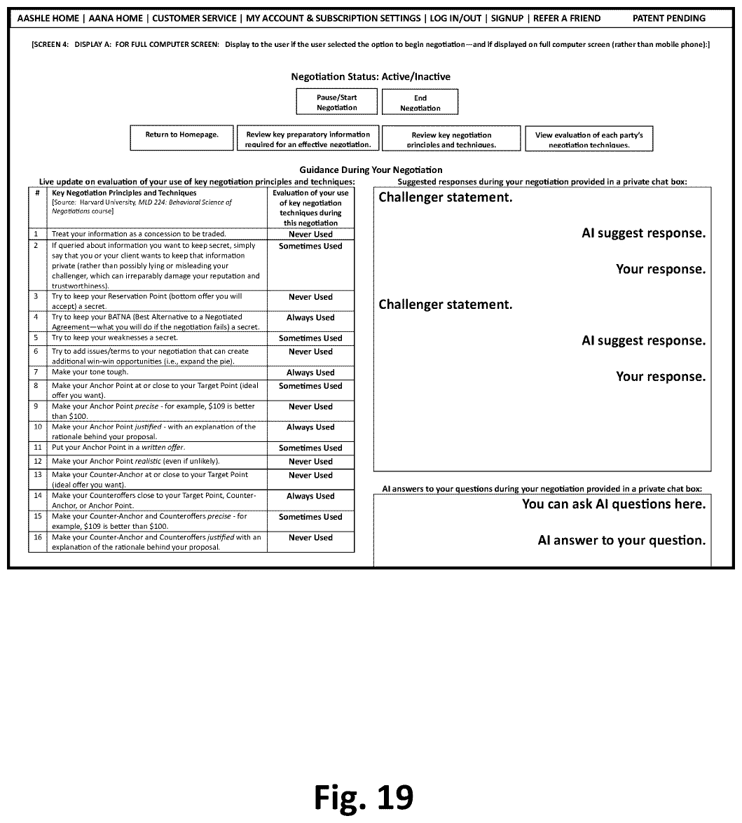

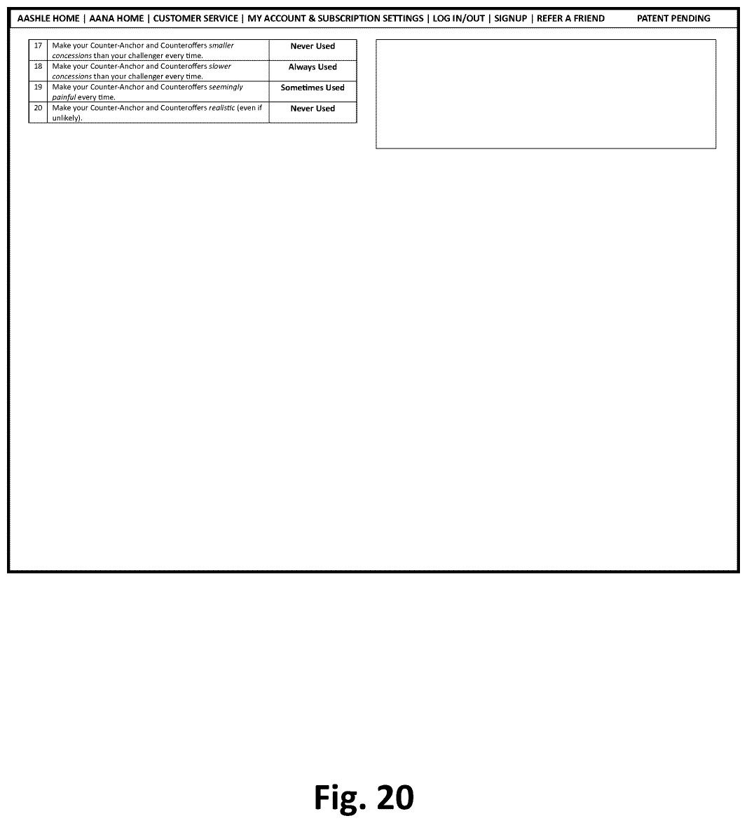

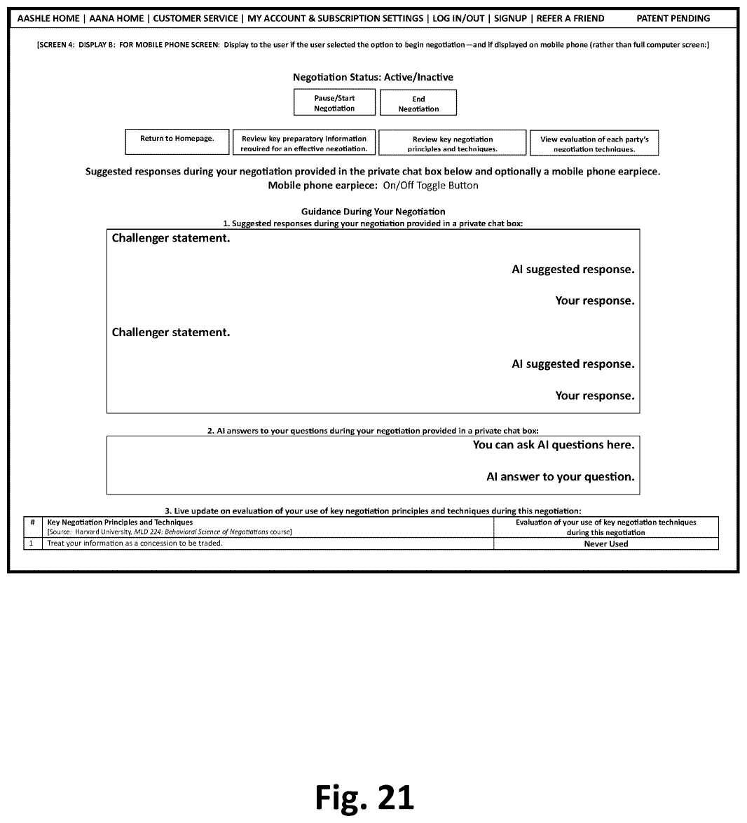

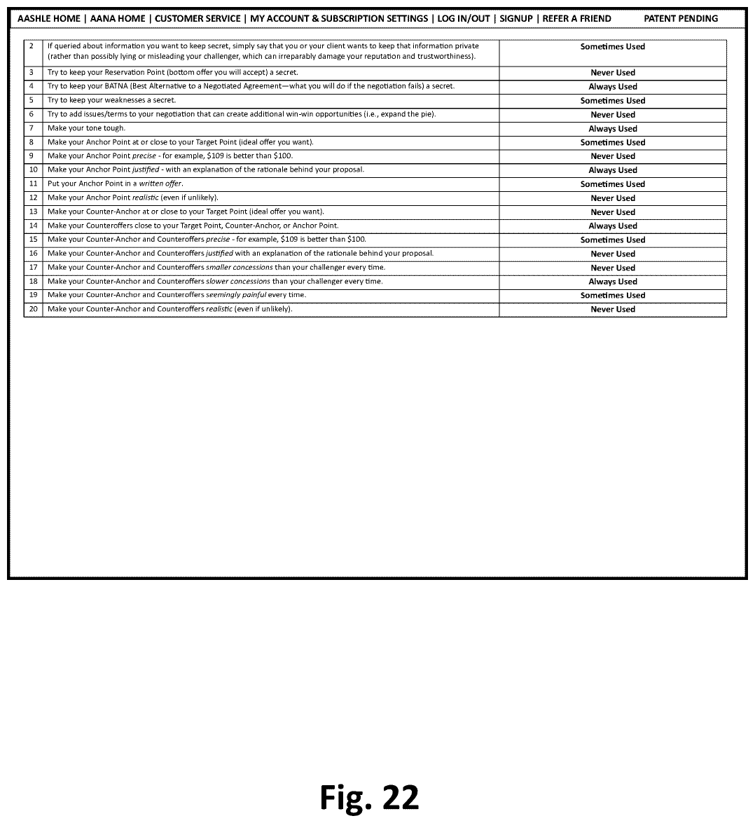

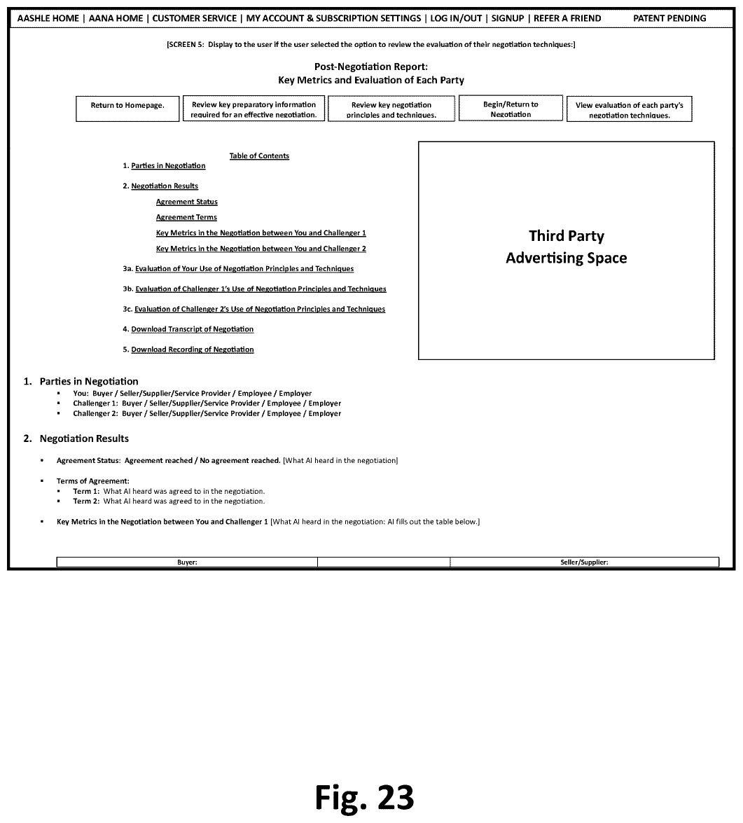

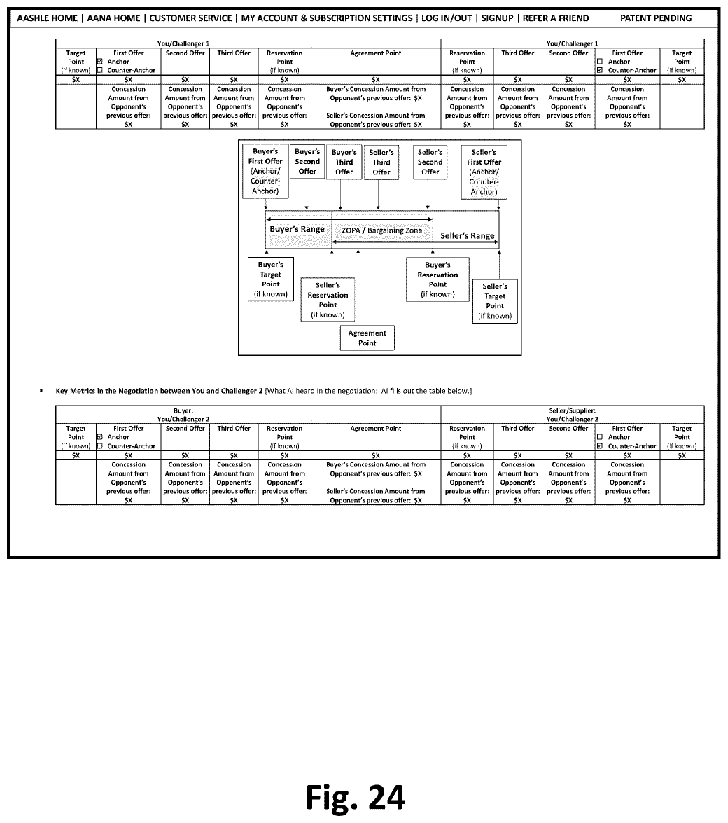

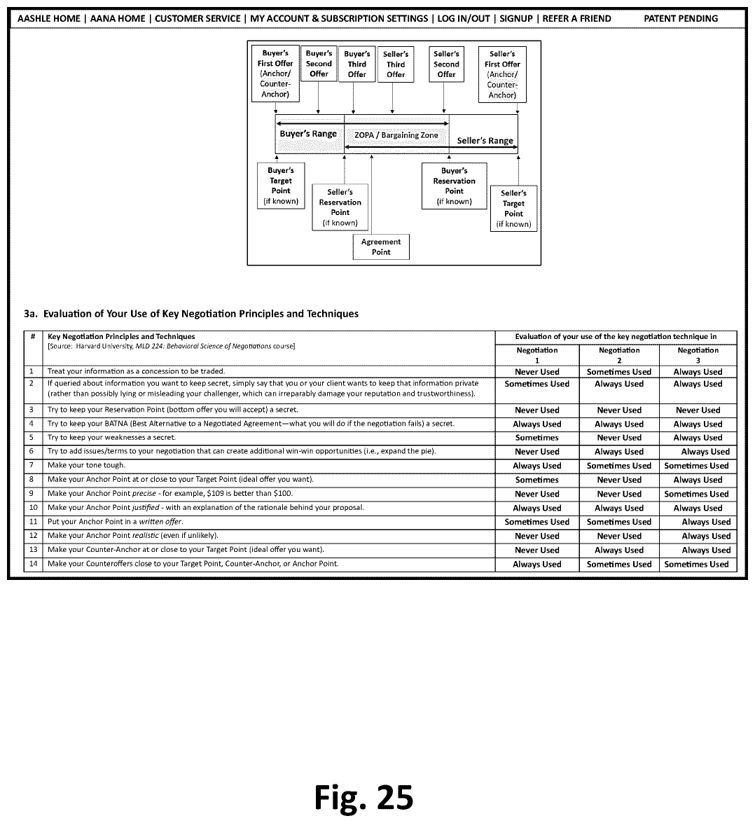

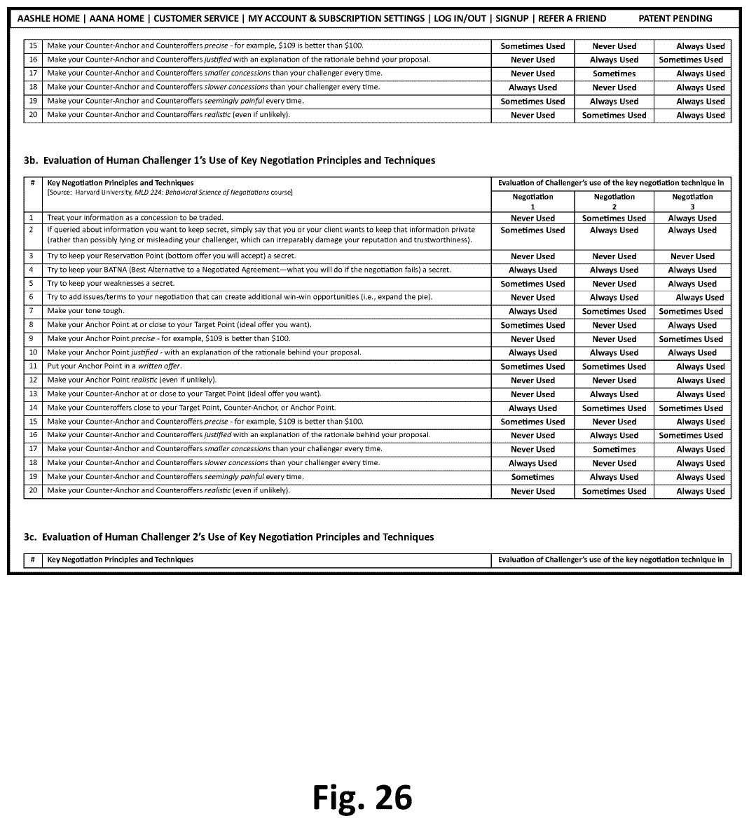

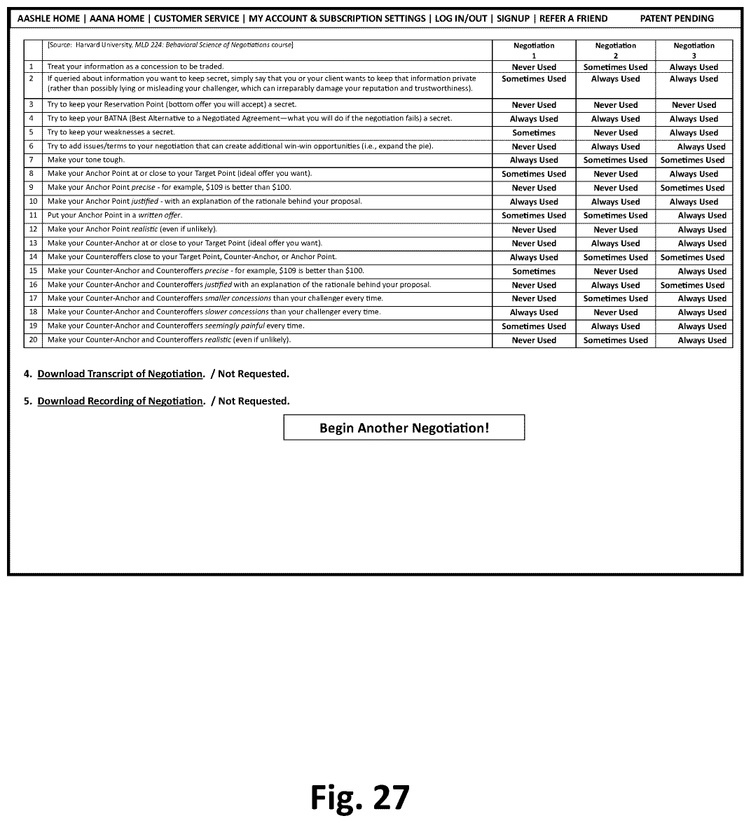

The interface provided by the system allows a user to interact with the disclosed system through a user device. The interface may include a series of screens which in continuation can provide information as well as receive information from the user for executing one or more steps of the disclosed methodology. FIGS. 5-27 show different screens of the interface. The interface can be dynamic and allows switching between sections, screens, pages, and the like quickly and easily. The interface can be provided as an application software that can be installed on the user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the World Wide Web. The application software can also be provided for the desktop environment, such as Windows™, Linux, and macOS. The user interface may permit interaction with a user through the user device, wherein information can be presented within the user interface by system 100 and information can be received by system 100 from the user.

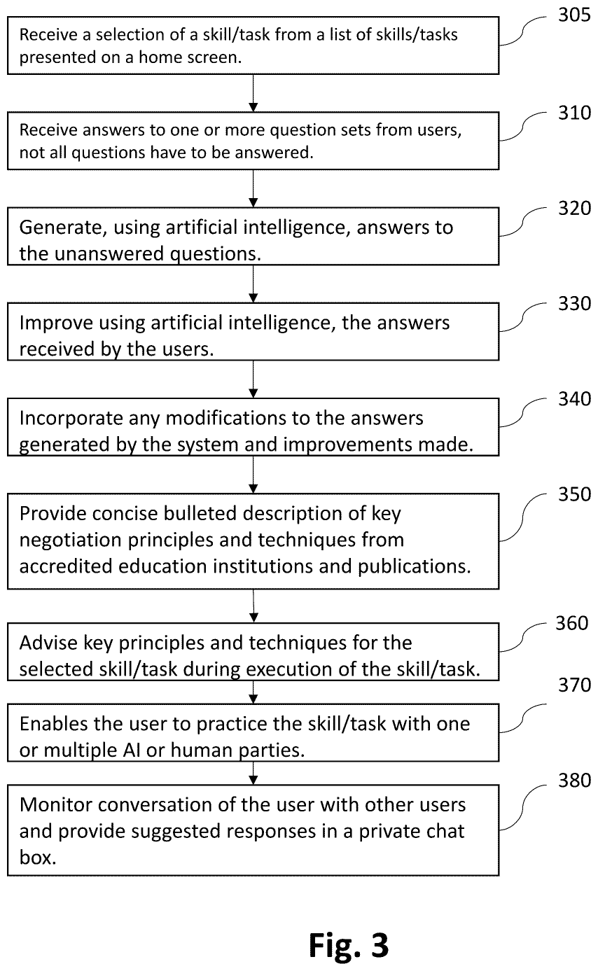

Referring to FIG. 3 which shows a flow chart illustrating the steps of the disclosed method. A user can be presented with a home screen of the interface on the user device. The home screen can list the available skills/tasks for the user to select. The user can select the skill/task they want assistance with, at step 305. Examples of such skills include negotiation; mediation; debate; legal exchange exercise; policy initiative, improvement, and evaluation; choice making, game theory, forecasting (predictive assessment), situational intelligence assessment; risk assessment & management; problem solving; strategy (a plan designed to overcome obstacles); plan implementation & supervision; Leadership, influencing, and supervising; and persuasive communication. It is however obvious that any number of skills/tasks can be added or removed without departing from the scope of the present invention. The user can select a skill through an interactive mechanism, such as the user can click a link associated with the skill. The selection by the user can connect the user with a respective AI engine of the system. The AI engine can then help the user learn, practice, execute, and evaluate the performance of a skill/task, and in some cases, can also execute the task on behalf of the user.

The home screen may also allow an individual to register with the disclosed system. The system can receive information about an individual, such as the name and email address of the individual. The system can be used to register the individual as a user of the system. The system can generate login credentials for the user for secure access to the system. The login credentials may contain a username and a password. The password can be any alphanumeric code. Biometric-based authentication is also within the scope of the present invention. It is understood that the system may verify the email address and any other information of the user.

Once the user selects a desired skill/task from a home screen, the user can be presented with a second screen. The second screen may include a form with free text fields that can be used to obtain information from the user. The user fills out free text fields about what they know or guesstimate in answer to just a few questions and optionally additional questions, specifying which information is known or guesstimated in each answer, at step 310. For example, from the second screen, the user fills out free text fields about what they know or guesstimate in answer to just the first few questions and optionally any other questions, specifying which information is known or guesstimated in each answer. It is to be noted that the user is not required to answer all the questions. Questions can be displayed on a screen of the user device so that the user can read the questions. Alternatively, the system can read the questions to the user. The questions for the negotiation app:
Question Set 1: Questions and guidance about key symmetric information—information that is known by all parties.
   1.1. What is your role in the negotiation? (Buyer, Seller, Supplier, Service Provider, Employee, Employer, Other Role?) Provide as much information as you like.
   1.2. Who are you negotiating against? (Buyer, Seller, Supplier, Service Provider, Employee, Employer, Other Role?) Provide as much information as you like.
   1.3. What is being negotiated, and what are the key issues? (Price, Base Salary, Bonuses, Commission, Holidays, Remote Versus On-Site Versus Hybrid Work Modes, Healthcare Benefits, Stock Options, Other?) Provide as much information as you like.
   1.4. Can you add any issues/terms to your negotiation that can create additional win-win opportunities (i.e., expand the pie)?
   1.5. Are there any deadlines for this negotiation? (These are typically beneficial to establish because they affect both parties equally in helping to expedite their decisions.)
Question Set 2: Questions and guidance about key asymmetric information—information that is not known by all parties.
   2.1a. Do you have any Time Costs (ongoing costs to only you as time passes until you reach a decision, such as attorney fees or lack of pay)?
      This is a weakness in your position because only you incur these costs as time passes.
      Try to keep this a secret.
   2.1b. Does your challenger have any Time Costs (ongoing costs to only your challenger as time passes until your challenger reaches a decision, such as attorney fees or lack of pay)?
      This is a weakness in your challenger's position because only your challenger incurs these costs as time passes.
      A good challenger will try to keep this a secret.
   2.2a. What is your Target Point (the ideal offer you want)?
      Should be so ambitious that you are unlikely to get it, but not unrealistic.
   2.2b. What is your challenger's Target Point (the ideal offer your challenger wants)?
      A good challenger will make this so ambitious that they are unlikely to get it, but not unrealistic.
   2.3a. What is your Reservation Point (the bottom offer you will accept)?
      Try to keep this a secret.
   2.3b. What is your challenger's Reservation Point (the bottom offers your challenger will accept)?
      A good challenger will try to keep this a secret.
   2.4a. What is your BATNA (Best Alternative to a Negotiated Agreement—what you will do if the negotiation fails)?
      Sometimes favorable for you. Sometimes unfavorable for you.
      Sometimes you are locked into an unfavorable BATNA.
      Try to keep this a secret.
      Instead of revealing your BATNA, reveal your rational for your BATNA.
   2.4b. What is your challenger's BATNA (Best Alternative to a Negotiated Agreement—what your challenger will do if the negotiation fails)?
      Sometimes favorable for your challenger. Sometimes unfavorable for your challenger.
      Sometimes your challenger is locked into an unfavorable BATNA.
      A good challenger will try to keep this a secret.
      Instead of revealing the BATNA, a good challenger will reveal the rational for the BATNA.
   2.5a. What are the strengths of your position?
      Sometimes you want to make these known to your challenger to demonstrate your capabilities/power.
   2.5b. What are your challenger's strengths, and how can you neutralize them?
      Your challenger might make these known to you to intimidate you.
   2.6a. What are the weaknesses of your position?
      Try to keep these a secret.
   2.6b. What are your challenger's weaknesses, and how can you amplify them?
      A good challenger will try to keep these a secret.
   2.7a. Have you established an initial Anchor Point (the first offer in a negotiation)?
      The Anchor Point often serves as a reference point for both parties in the negotiation.
         . The Anchor helps frame the negotiation and steers the conversation to keep the focus on issues that matter most to your goals.
         The Anchor enables you to shape the other party's perception of a reasonable outcome, which can influence their willingness to compromise in your favor.
      The Anchor is more effective (sticks better) if it is—
         At or close to your Target Point (ideal offer you want).
         Precise—for example, $109 is better than $100.
         Justified—with an explanation of the rationale behind your proposal.
         In a Written Offer.
         Realistic (even if unlikely)—Setting an extreme or unrealistic anchor can backfire by alienating them to her party and making it difficult to reach an agreement; it is important to challenge your challenger strategically and ethically.
      The Anchor is only effective if you stay close to your anchor in the negotiation.
         2.7b. Has your challenger established an initial Anchor Point (the first offer in a negotiation)?
         2.8a. Have you established a Counter-Anchor (a response to the initial Anchor Point set by the other party) or made any Counteroffers?
The Counter-Anchor and the Counteroffers are more effective if they are—
   At or kept close to your Target Point (the ideal offer you want), your Counter-Anchor, or your Anchor Point:
      The Counter-Anchor is only effective if you stay close to your Target Point or Counter-Anchor in the negotiation.
      The Counteroffers are only effective if you stay close to your Target Point, Counter-Anchor, or Anchor Point in the negotiation.
   Precise—for example, $109 is better than $100.
   Justified with an explanation of the rationale behind your proposal.
   Smaller concessions than your challenger every time.
   Slower concessions than your challenger every time.
   Seemingly painful every time, so your challenger feels like you have made a big concession.
   Realistic (even if unlikely)—Setting an extreme or unrealistic counteroffer can backfire by alienating the other party and making it difficult to reach an agreement; it's important to counter your challenger strategically and ethically.
If your challenger makes a really good argument, then do not hesitate to say let's break, so you break their momentum and can think of a good counter.
   2.8b. Has your challenger established a Counter-Anchor (a response to the initial Anchor Point set by the other party) or made any Counteroffers?
   2.9a. Are there any questions you want to ask your challenger?
      Include questions that can help you figure out how to add any issues/terms to your negotiation that can create additional win-win opportunities (i.e., expand the pie).
   2.9b. What questions do you expect your challenger to ask you?
      A good challenger will include questions that help them figure out how to add any issues/terms to the negotiation that can create additional win-win opportunities (i.e., expand the pie).

Once the information through different forms can be obtained from the user. The system, using AI, can then answer the unanswered questions with known or guesstimated information-specifying which information is known or guesstimated. The system, using AI, can then answer the unanswered questions with known or guesstimated information-specifying which information is known or guesstimated, at step 320. This step saves the use preparation time and provides the user with key information required to perform the selected skill/task effectively. For example, this step saves the use preparation time for a negotiation and provides the user with key information required for an effective negotiation and suggestions for using the information effectively.

Thereafter, the system can improve upon the answers provided by the user, at step 330. The user optionally edits any of the AI-generated information in any of the fields with the answers to all the questions in the template, at step 340. Thereafter, AI can incorporate the user's revisions. For example, the user optionally edits any of the AI-generated information in any of the twenty-three fields with the answers to the twenty-three questions, and then AI incorporates the user's revisions.

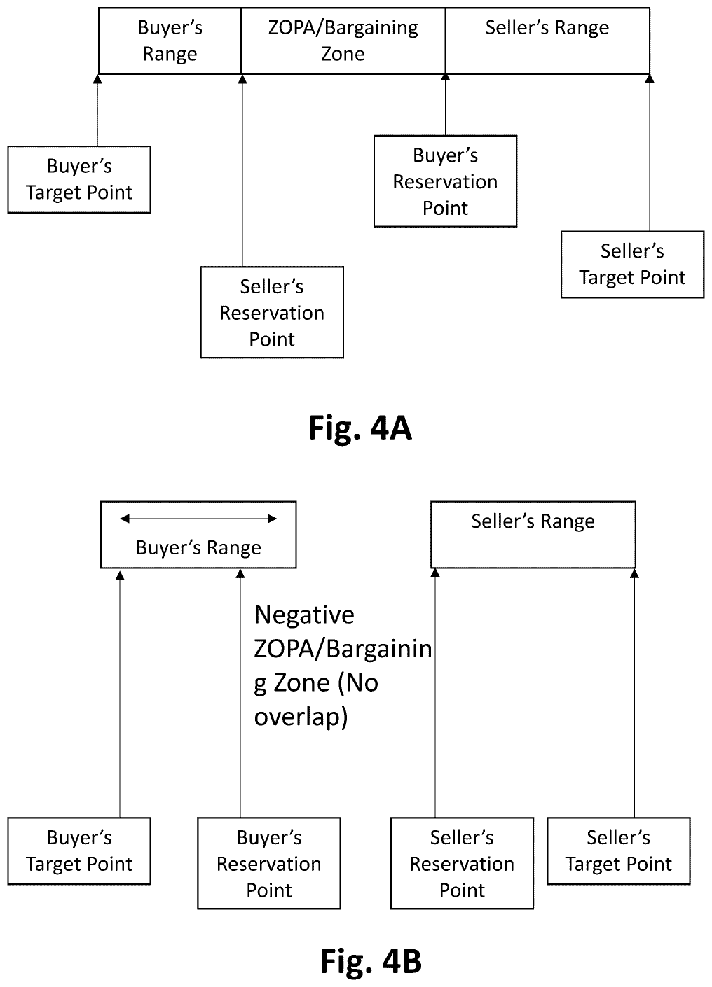

The system can then provide the user with a concise bulleted description of key negotiation principles and techniques from accredited education institutions and publications, at step 350. For example, the concise bulleted description of negotiation-guiding principles and techniques includes at least the following:
Negotiations are often characterized by ‘information asymmetries’—one side has a piece of important information, and the other side needs it to make good decisions. Furthermore, the side that has the information is often not eager to reveal it.”
Most of the work in a negotiation happens before rather than at the negotiation.
Don't start until you are ready.
Seek the information described in the above fields before you begin your negotiation.
Treat your information as a concession to be traded.
If queried about information you want to keep secret,
   simply say that you or your client wants to keep that information private;
   do not lie or mislead your challenger, which can irreparably damage your reputation and trustworthiness if you are caught.
Try to keep the following information secret:
   Your Reservation Point (bottom offer you will accept).
   Your BATNA (Best Alternative to a Negotiated Agreement—what you will do if the negotiation fails).
      Sometimes favorable for you. Sometimes unfavorable for you.
      Sometimes you are locked into an unfavorable BATNA.
      Instead of revealing your BATNA, reveal your rational for your BATNA.
   Your weaknesses.
Try to add issues/terms to your negotiation that can create additional win-win opportunities (i.e., expand the pie):
   This requires you to share some of your interests and priorities and ask your challenger to share some of their interests and priorities.
   As information is exchanged, and trust is established, try to find ways to increase the pie—add issues/terms to the negotiation to that can create additional win-win opportunities.
   A philosophy on the overall goal in negotiation (in four parts): (1) Make the pie as big as possible, (2) claim as much as possible for yourself, (3) subject to fairness, and (4) subject to positive relationships with others.
Make your tone tough:
   For years we thought a nice/warm tone wouldn't hurt anything, but in reality, tough get better results.
   Tough indicate powerful and gets better counteroffers.
   Warm/nice does not indicate powerful and gets worse counteroffers.
   If your tone is tough, then gender doesn't matter, but if your tone is not tough, then males get better counteroffers.
   Adding humor is often really great.
   If you are clearly more powerful, you can afford to add warmth.
   If you negotiate tough, then you can be warm in the end, so your challenger remembers you were warm.
Anchor Point principles:
   The Anchor Point often serves as a reference point for both parties in the negotiation.
      The Anchor helps frame the negotiation and steers the conversation to keep the focus on issues that matter most to your goals.
      The Anchor enables you to shape the other party's perception of a reasonable outcome, which can influence their willingness to compromise in your favor.
   The Anchor is more effective (sticks better) if it is—
      At or close to your Target Point (ideal offer you want).
      Precise—for example, $109 is better than $100.
      Justified—with an explanation of the rationale behind your proposal.
      In a Written Offer.
      Realistic (even if unlikely)—Setting an extreme or unrealistic anchor can backfire by alienating the to her party and making it difficult to reach an agreement; it's important to challenge your challenger strategically and ethically.
   The Anchor is only effective if you stay close to your anchor in the negotiation.
Counter-Anchor and Counteroffer Principles:
   The Counter-Anchor and the Counteroffers are more effective if they are—
      At or kept close to your Target Point (ideal offer you want), your Counter-Anchor, or your Anchor Point:
         The Counter-Anchor is only effective if you stay close to your Target Point or Counter-Anchor in the negotiation.
         The Counteroffers are only effective if you stay close to your Target Point, Counter-Anchor, or Anchor Point in the negotiation.
      Precise—for example, $109 is better than $100.
      Justified with an explanation of the rationale behind your proposal.
      Smaller concessions than your challenger every time.
      Slower concessions than your challenger every time.
      Seemingly painful every time, so your challenger feels like you have made a big concession.
      Realistic (even if unlikely)—Setting an extreme or unrealistic counteroffer can backfire by alienating the other party and making it difficult to reach an agreement; it's important to counter your challenger strategically and ethically.
   If your challenger makes a really good argument, then don't hesitate to say let's break, so you break their momentum and can think of a good counter.
ZOPA: Zone of Possible Agreement: Bargaining Zone: The overlap between what each party is willing to accept or offer (shown in FIG. 4A)
Negative ZOPA: A situation in which there is no overlapping range between the acceptable terms of the parties involved.
   In other words, there is no common ground where both parties' minimum and maximum acceptable terms align, which means that it is extremely challenging, if not impossible, to reach a mutually satisfactory agreement.
   Before you accept you have a negative ZOPA, try to find additional issues/terms to add to your negotiation that can create win-win opportunities (i.e., expand the pie) (shown in FIG. 4B).

At step 360, the system can then behave according to the key principles and techniques for that skill/task during the execution of that skill/task and give the user advice according to those key principles and techniques for that skill/task. For example, AI is instructed to behave according to the key negotiation principles and techniques during negotiations and to give the user advice according to the key negotiation principles and techniques.

If applicable for the skill/task, the system enables the user to verbally (or via chat box) practice the skill/task with one or multiple AI or human parties, at step 370, while AI listens and provides all parties or only selected parties suggested responses in a private chat box or cell phone earpiece in real-time, at step 380.

To enable AI to recognize which human is speaking during a verbal exchange, the humans are equipped with devices that inform AI when they are speaking. This solves the problem of AI needing to train on voice recognition for each human and the problem of AI potentially struggling with voice recognition. The user can also be provided with an option to switch between talking or texting with all parties simultaneously or alternate between talking or texting with just one or more selected parties. The system may also display a second chat box for a user to ask questions to the system during the verbal or text exchange. The user does not have to search for information from different sources to find relevant facts. The system can provide all the information, in near real-time, through a second chat box. The second chat box can be the private chat box.

Optionally, the live verbal or text exchange screen provides the user a section that shows a live update on an evaluation of the user's use of the key principles and techniques for the skill/task on a three-level scale of always used, sometimes used, or never used. The live evaluation provides the user with a prevalent reminder of the key principles and techniques to promote improvement in the user's habits with each and every practice session. Thus, the user while in negotiation can know his standing in the negotiation process in near real-time. This may also help to change the course of negotiation. For example, the user may have said something which should be held hidden. The system can notify the user about the same and the user can take suitable action.

The live verbal or text exchange screen provides the user with a button to pause or start the exchange. The live verbal or text exchange screen provides the user a button to review the detailed explanation of the key principles and techniques to perform the skill/task effectively. The live verbal or text exchange screen provides the user a button to review the key preparatory information required to perform the skill/task effectively and the app's suggestions for using the information effectively. Thus, the user can pause the ongoing negotiation and review the process, seek any improvements, and the like. For example, the system enables the user to verbally (or via chat box) practice the negotiation against one or multiple AI or human challengers, while AI listens and provides all parties or only selected parties suggested responses in a private chat box or mobile phone earpiece in real-time. The interface can show a second chat box that enables the user to ask AI questions during the negotiation.

Optionally, the negotiation screen provides the user a section that shows a live update on an evaluation of the user's use of the key negotiation principles and techniques, as abbreviated in the list below, on a three-level scale of always used, sometimes used, or never used.

An abbreviated list of the key negotiation principles and techniques: (1) Treat your information as a concession to be traded. (2) If queried about the information you want to keep secret, simply say that you or your client wants to keep that information private (rather than possibly lying or misleading your challenger, which can irreparably damage your reputation and trustworthiness). (3) Try to keep your Reservation Point (bottom offer you will accept) a secret. (4) Try to keep your BATNA (Best Alternative to a Negotiated Agreement—what you will do if the negotiation fails) a secret. (5) Try to keep your weaknesses a secret. (6) Try to add issues/terms to your negotiation that can create additional win-win opportunities (i.e., expand the pie). (7) Make your tone tough. (8) Make your Anchor Point at or close to your Target Point (the ideal offer you want). (9) Make your Anchor Point precise—for example, $109 is better than $100. (10) Make your Anchor Point justified—with an explanation of the rationale behind your proposal. (11) Put your Anchor Point in a written offer. (12) Make your Anchor Point realistic (even if unlikely). (13) Make your Counter-Anchor at or close to your Target Point (the ideal offer you want). (14) Make your Counteroffers close to your Target Point, Counter-Anchor, or Anchor Point. (15) Make your Counter-Anchor and Counteroffers precise—for example, $109 is better than $100. (16) Make your Counter-Anchor and Counteroffers justified with an explanation of the rationale behind your proposal. (17) Make your Counter-Anchor and Counteroffers smaller concessions than your challenger every time. (18) Make your Counter-Anchor and Counteroffers slower concessions than your challenger every time. (19) Make your Counter-Anchor and Counteroffers seemingly painful every time. (20) Make your Counter-Anchor and Counteroffers realistic (even if unlikely).

Three-level Evaluation Scale: Always used; Sometimes used; and never used. The live evaluation provides the user with a prevalent reminder of the key negotiation principles and techniques to promote improvement in the user's negotiation habits with each and every practice session.

If applicable for the skill/task, the system, only if requested, listens to the user's actual verbal exchange for the selected skill/task to provide only the user-suggested responses in a private chat box or mobile phone earpiece in real-time. For example, the system, only if requested, listens to the user's actual negotiation to provide only the user-suggested responses in a private chat box or mobile phone earpiece in real-time.

Optionally, as previously described, during negotiation, a section is presented that shows a live update on an evaluation of the user's use of the key negotiation principles and techniques on a three-level scale of always used, sometimes used, or never used.

If applicable for the skill/task, the system, only if requested, creates a recording of the user's verbal exchange (such as a negotiation). If applicable for the skill/task, the system, only if requested, creates a transcript of the user's verbal exchange (such as a negotiation). If applicable for the skill/task, based on what AI heard/observed in the verbal or text exchange, the system gives the user a written (and optionally verbal) Post-Exchange Report that provides at least key metrics and an evaluation of the user's use of the key principles and techniques for the skill/task on a three-level scale of always used, sometimes used, or never used. For example, based on what AI heard/observed in a negotiation, AI gives the user a written (and optionally verbal) Post-Negotiation Report that provides at least the following:
The list of parties in the negotiation.
The negotiation outcome, which includes at least the following:
   Whether an agreement was reached.
   A list of the terms of the negotiation.
   Key metrics, which include at least the following:
      each party's target point, if known;
      each party's reservation point, if known;
      each party's counteroffers;
      each counteroffer's concession amount from the opponent's previous offer;
      the time elapsed between each party's offers; and
      the agreement points.
   A chart that indicates the following on a proportionate scale:
      each party's target point, if known;
      each party's reservation point, if known;
      the Zone of Possible Agreement (ZOPA), if known;
      each party's counteroffers;
      each counteroffer's concession amount from the opponent's previous offer;
      the time elapsed between each party's offers; and
      the agreement points.
An evaluation of each party's use of the key negotiation principles and techniques on the following three-level scale:
   Always used.
   Sometimes used.
   Never used.

The written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system based on artificial Intelligence (AI), a systematic process, key principles and techniques of a skill/task, and process-guiding templates for helping users learn, practice, execute, and evaluate a performance of the skill/task, or to execute the task for them, the system comprising a processor and a memory, the system configured to implement a method comprising:
receiving a selection of a skill/task from a list of skills/tasks presented on a home screen of an interface implemented on a user device by the system;
receiving answers to one or more question sets from a user for a negotiation exercise through an interface implemented on the user device, wherein the answers are received through free text fields, wherein some questions of the one or more question sets remain unanswered;
generating, using artificial intelligence, answers to the unanswered questions;
improving by the system, using artificial intelligence, the answers received by the system from the user;
receiving any modifications to the answers generated by the system and improvements made, from the user;
displaying, by the system, concise bulleted description of key negotiation principles and techniques from accredited education institutions and publications on the user device;
advising, by the system, key principles and techniques for the selected skill/task during the execution of the skill/task; and
implementing a first chat box on the user device through the interface for allowing the user to practice/converse the skill/task with other users or the system.

2. The system of claim 1, wherein the first chat box is configured to allow the user to practice/converse using text messages.

3. The system of claim 2, wherein the first chat box is further configured to allow the user to practice/converse verbally, wherein the system is configured to read for the user.

4. The system of claim 2, wherein the system is configured to read/listen to the first chat box.

5. The system of claim 4, wherein the system is configured to analyze the conversations in the first chat box in near real-time and present suggestions on the practice/conversation through a second chat box, the second chat box is private to the user.

6. The system of claim 5, wherein the system is configured to receive queries from the user related to the practice/conversation through the second chat box.

7. The system of claim 5, wherein the system is further configured to evaluate a performance of the user in applying the key principles and techniques for the selected skill/task in the practice/conversation.

8. The system of claim 1, wherein the skill is selected from a group consisting of negotiation; mediation; debate; legal exchange exercise; policy initiative, improvement, and evaluation; choice making; game theory; forecasting (predictive assessment); situational intelligence assessment; risk assessment & management; problem solving; strategy making; plan implementation & supervision; Leadership, influencing, and supervising; and persuasive communication.

9. The system of claim 7, wherein the evaluation is on a three-level scale, the three-level scale includes always used, sometimes used, or never used.

10. The system of claim 1, wherein the answers can be from known knowledge or guesstimate, wherein each answer is marked as known or guesstimate respectively.

11. A method based on artificial Intelligence (AI), a systematic process, key principles and techniques of a skill/task, and process-guiding templates for helping users learn, practice, execute, and evaluate a performance of the skill/task, or to execute the task for them, the method implemented within a system comprising a processor and a memory, the method comprising:
receiving a selection of a skill/task from a list of skills/tasks presented on a home screen of an interface implemented on a user device by the system;
receiving answers to one or more question sets from a user for a negotiation exercise through an interface implemented on the user device, wherein the answers are received through free text fields, wherein some questions of the one or more question sets remain unanswered;
generating, using artificial intelligence, answers to the unanswered questions;
improving by the system, using artificial intelligence, the answers received by the system from the user;
receiving any modifications to the answers generated by the system and improvements made, from the user;
displaying, by the system, concise bulleted description of key negotiation principles and techniques from accredited education institutions and publications on the user device;
advising, by the system, key principles and techniques for the selected skill/task during the execution of the skill/task; and
implementing a first chat box on the user device through the interface for allowing the user to practice/converse the skill/task with other users or the system.

12. The method of claim 11, wherein the first chat box is configured to allow the user to practice/converse using text messages.

13. The method of claim 12, wherein the first chat box is further configured to allow the user to practice/converse verbally, wherein the system is configured to read for the user.

14. The method of claim 12, wherein the system is configured to read/listen to the first chat box.

15. The method of claim 14, wherein the system is configured to analyze the conversations in the first chat box in near real-time and present suggestions on the practice/conversation through a second chat box, the second chat box is private to the user.

16. The method of claim 15, wherein the system is configured to receive queries from the user related to the practice/conversation through the second chat box.

17. The method of claim 15, wherein the system is further configured to evaluate a performance of the user in applying the key principles and techniques for the selected skill/task in the practice/conversation.

18. The method of claim 11, wherein the skill is selected from a group consisting of negotiation; mediation; debate; legal exchange exercise; policy initiative, improvement, and evaluation; choice making; game theory; forecasting (predictive assessment); situational intelligence assessment; risk assessment & management; problem solving; strategy making; plan implementation & supervision; Leadership, influencing, and supervising; and persuasive communication.

19. The method of claim 17, wherein the evaluation is on a three-level scale, the three-level scale includes: always used, sometimes used, and never used.

20. The method of claim 11, wherein the answers can be from known knowledge or guesstimate, wherein each answer is marked as known or guesstimate respectively.
